(19) United States
(12) Patent Application Publication
(10) Pub. No.: US 2008/0225403 A1
(43) Pub. Date: Sep. 18, 2008

(54) Variable Focus Lens Package Having Clamping Means For Fixing the Various Lens Package Elements With Respect to Each Other

(75) Inventors: Johannus Wilhelmus Weekamp, Eindhoven (NL); Edwin Maria Wolterink, Eindhoven (NL); Kornelis Renkema, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/597,416

(22) PCT Filed: Jan. 24, 2005
(86) PCT No.: PCT/IB2005/050265

§ 371 Date: Jul. 25, 2006

(30) Foreign Application Priority Data
Jan. 30, 2004 (EP) 04100351.8

(51) Int. Cl. G02B 3/14; G02B 7/02

(52) U.S. Cl. 359/666; 359/818

(57) ABSTRACT

A variable focus lens package (2) comprises an annular body (10) having a through-hole (11), which is closed off by means of lens members (30, 70), and which is sealed by means of sealing rings (50, 60). The through-hole (11) is filled with quantities of water (86) and oil (87), which are separated by a meniscus (88). The various lens package elements are fixed with respect to each other by means of clamping units (20a, 20b). By this arrangement, a very compact and robust lens package (2) is obtained. A portion of the surface of the body (10) is covered with an electrically conducting layer (16). The shape of the meniscus (88) is variable under the influence of a voltage between this electrically conducting layer (16) and the water (86). In this way, the meniscus (88) is applicable as a lens having an adjustable focus.

The present invention relates to a variable focus lens package, comprising:

a body, which is provided with a through-hole for providing a light path through the body, wherein at least a surface layer of the body comprises an electrically conducting material;

covers for closing off the through-hole, which are optically transparent in the light path;

an electrically insulating fluid and an electrically conducting fluid, which are contained by a fluid chamber enclosed by the covers and an inner surface of the through-hole of the body, which are non-miscible, and which are in contact over a meniscus, wherein a shape of the meniscus is variable under the application of a voltage between the electrically conducting surface of the body and the electrically conducting fluid; and

an electrically insulating layer covering at least the portion of the surface of the body contacting the electrically conducting fluid.

A variable focus lens package in which light is refracted by a meniscus between two fluids, wherein the shape of the meniscus is variable under the influence of a voltage, is known. In general, such a variable focus lens package is provided with a through-hole for letting through light, which is closed off at both ends, whereby a closed fluid chamber for containing the fluids is obtained. One of the fluids has electrically insulating properties, whereas another of the fluids has electrically conducting properties. The fluids are non-miscible, and tend to form two fluid bodies separated by a meniscus. Functionally, the fluids have different indices of refraction.

For the purpose of applying a voltage, the variable focus lens package comprises two electrical connectors of which at least a portion is arranged at the outside of the lens package. A first electrical connector is separated from the electrically conducting fluid, whereas a second electrical connector is in direct contact with the electrically conducting fluid, or is capacitively coupled thereto.

WO 03/069380 discloses a variable focus lens package in which an inner surface of the through-hole is covered by a hydrophobic fluid contact layer. When no voltage is applied, the wettability of the fluid contact layer with respect to the electrically insulating fluid differs from the wettability of the fluid contact layer with respect to the electrically conducting fluid. Due to an effect referred to as electrowetting, the wettability of the fluid contact layer with respect to the electrically conducting fluid is variable under the application of a voltage between the first connector and the second connector. A change of the wettability of the fluid contact layer leads to a change of a contact angle of the meniscus at a line of contact between the fluid contact layer and the two fluids, whereby the shape of the meniscus is adjusted. Hence, the shape of the meniscus is dependent on the applied voltage.

Although the application of electrowetting effects for the purpose of providing a variable focus lens is a relatively new technique, a considerable number of variable focus lens packages has already been developed. It is an objective of the present invention to provide a newly designed variable focus lens package, which is compact and robust. In particular, the variable focus lens package according to the present invention must be suitable for application in a mobile phone, and must therefore be capable of meeting all requirements associated with such an application.

The set objective is achieved by a variable focus lens package, comprising:

a body, which is provided with a through-hole for providing a light path through the body, wherein at least a surface layer of the body comprises an electrically conducting material;

covers for closing off the through-hole, which are optically transparent in the light path;

an electrically insulating fluid and an electrically conducting fluid, which are contained by a fluid chamber enclosed by the covers and an inner surface of the through-hole of the body, which are non-miscible, and which are in contact over a meniscus, wherein a shape of the meniscus is variable under the application of a voltage between the electrically conducting surface of the body and the electrically conducting fluid;

an electrically insulating layer covering at least the portion of the surface of the body contacting the electrically conducting fluid;

sealing means for sealing the fluid chamber; and

clamping means for fixing the body, the covers and the sealing means with respect to each other under the exertion of clamping forces.

In the variable focus lens package according to the present invention, the fluid chamber is sealed by means of separate sealing means, which prevent the fluids from leaking out of the fluid chamber through a space between the body and the covers. According to an important aspect of the present invention, the variable focus lens package comprises clamping means for fixing the body, the covers and the sealing means with respect to each other under the exertion of clamping forces.

The design of the variable focus lens package according to the present invention is relatively simple, as a result of which a robust lens package is obtained, which is relatively easy to manufacture. Due to the presence of the clamping means, it is not necessary to apply soldering techniques for joining the body, the covers and the sealing means.

Furthermore, the insulating layer for covering at least a portion of the surface of the body may be applied before the assembly of the variable focus lens package takes place, so that measures for shielding other elements of the lens package during the application of the insulating layer are not necessary.

An important advantage of the variable focus lens package according to the present invention is that the clamping means may be arranged not only to clamp the various lens package elements, but also to constitute one connector or even both connectors of the lens package. For example, for the purpose of constituting both connectors of the variable focus lens package, the clamping means contact the electrically conducting fluid on the one hand and the electrically conducting surface of the body on the other hand. It will be understood that in such a case, the clamping means need to comprise two separate portions, in order to avoid short-circuiting in the variable focus lens package. Furthermore, it will be understood that the clamping means need to comprise an electrically conducting material in order to be capable of functioning as connectors.

The present invention will now be explained in greater detail with reference to the figures, in which similar parts are indicated by the same reference signs, and in which:

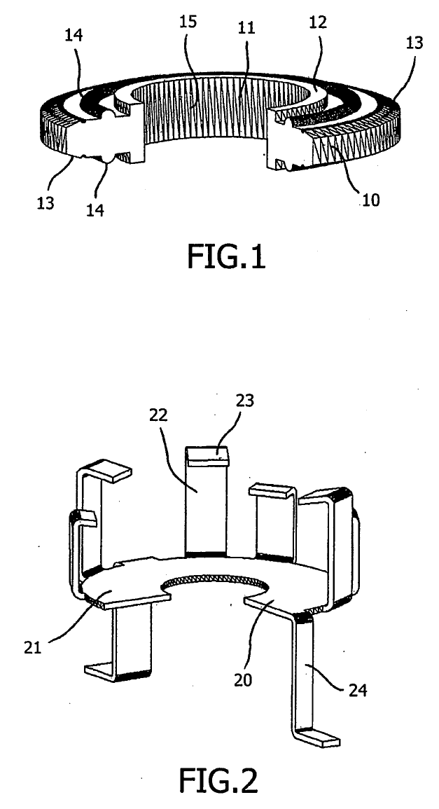

FIG. 1 diagrammatically shows a perspective view of a body of a variable focus lens package according to a first preferred embodiment of the present invention, wherein a portion of the body is broken away;

FIG. 2 diagrammatically shows a perspective view of a clamping unit of the variable focus lens package according to the first preferred embodiment of the present invention, wherein a portion of the clamping unit is broken away;

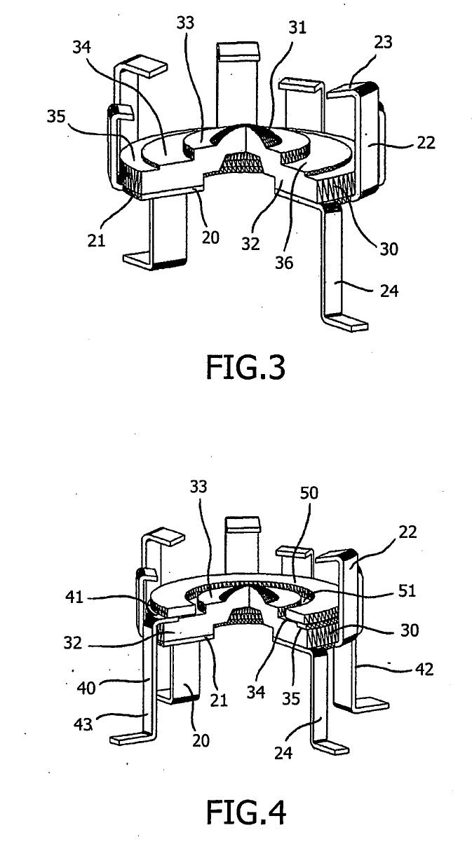

FIGS. 3-6 diagrammatically illustrate a way of assembling the variable focus lens package according to the first preferred embodiment of the present invention;

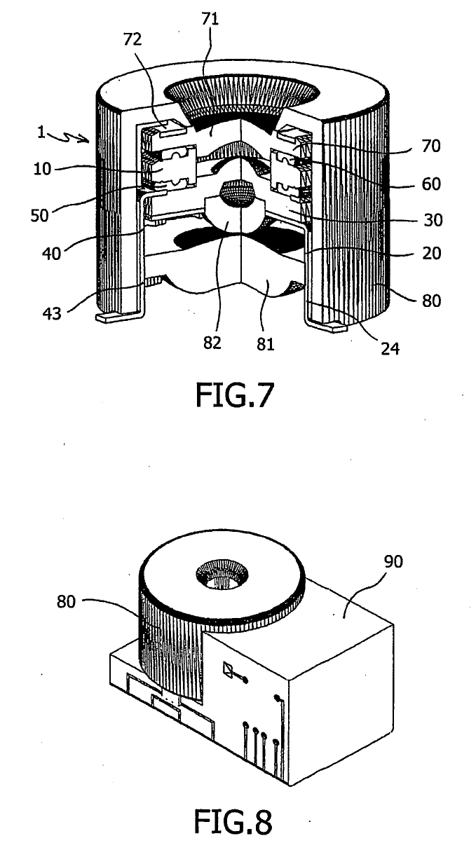

FIG. 7 diagrammatically shows a perspective view of a barrel containing the variable focus lens package according to the first preferred embodiment of the present invention and other optical elements, wherein a portion of the barrel and the elements inside the barrel is broken away;

FIG. 8 diagrammatically shows a perspective view of the barrel as shown in FIG. 7 and a camera module onto which the barrel is fitted;

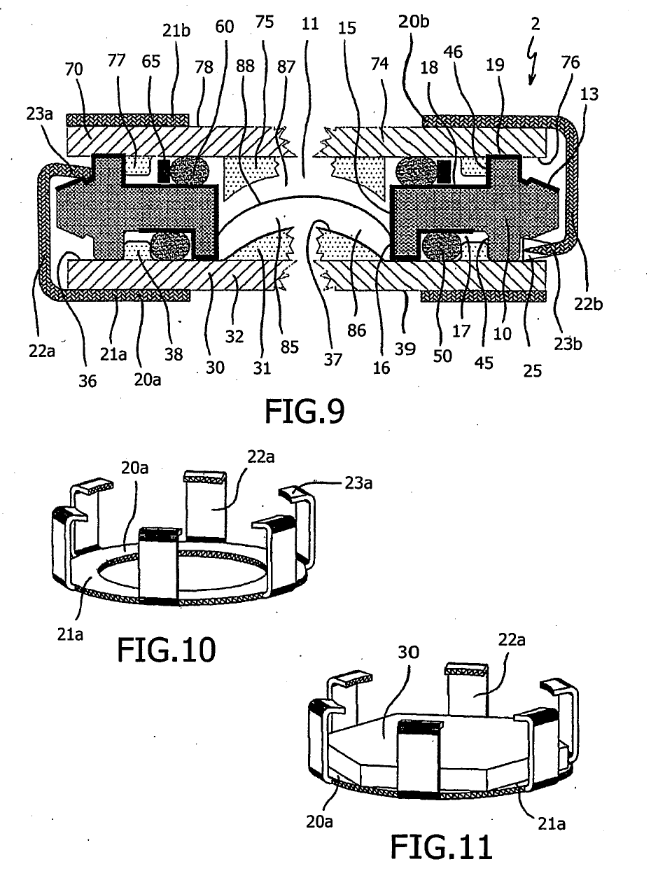

FIG. 9 diagrammatically shows a sectional view of a variable focus lens package according to a second preferred embodiment of the present invention;

FIGS. 10-14 diagrammatically illustrate a way of assembling the variable focus lens package according to the second preferred embodiment of the present invention;

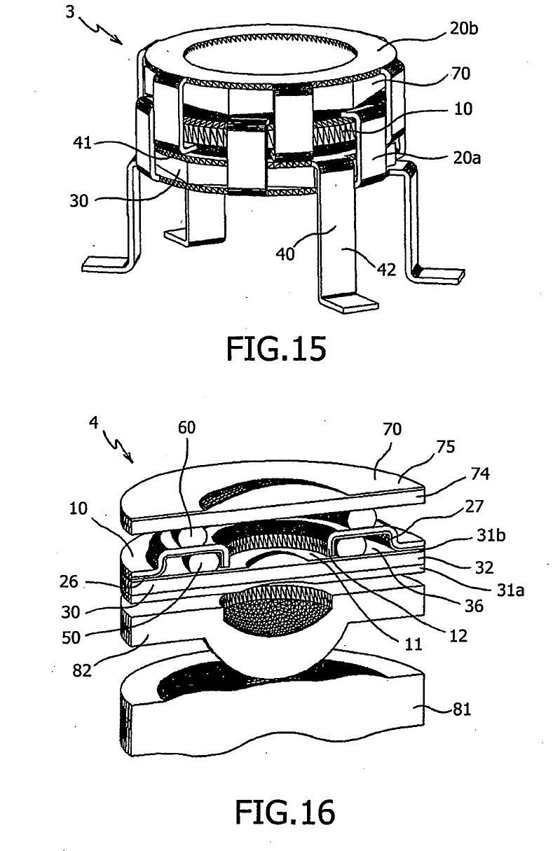

FIG. 15 diagrammatically shows a perspective view of a variable focus lens package according to a third embodiment of the present invention; and

FIG. 16 diagrammatically shows an exploded view of a section of a variable focus lens package according to a fourth embodiment of the present invention and two lens members.

FIG. 1 diagrammatically shows a body 10 of a variable focus lens package according to a first preferred embodiment of the present invention. In FIG. 1, for the sake of clarity, a portion of the body 10 is broken away.

The body 10 is annular, and comprises a through-hole 11. In the shown example, the through-hole 11 is shaped as a cylinder having a circular transverse section.

An inner portion 12 of the body 10 is shaped like a hollow cylinder. At both a bottom side and a top side of the body 10, an outer portion of the body 10 comprises a bevelling surface 13. Furthermore, at both a bottom side and a top side of the body 10, at a position between an outer circumference and an inner circumference of the body 10, an annular thickened portion 14 is provided.

The body 10 may for example be a copper element. At least an inner surface 15 of the inner portion 12 of the body 10 is provided with a number of coatings. A first coating may for example comprise black copper oxide, a second coating may for example comprise an electrically insulating material such as parylene, and a third coating may for example comprise a hydrophobic layer.

The particulars regarding the shape of the body 10 play a role in the process of assembling the first variable focus lens package comprising the body 10, whereas the particulars regarding the material of the body 10 and the layers play a role in the functioning of the first variable focus lens package. Both the process of assembling the first variable focus lens package and the functioning of the first variable focus lens package will be discussed in the following.

FIG. 2 diagrammatically shows a clamping unit 20 of the first variable focus lens package according to the first preferred embodiment of the present invention. In FIG. 2, for the sake of clarity, a portion of the clamping unit 20 is broken away.

The clamping unit 20 comprises a ring 21 and a number of clamping arms 22 extending from an outer circumference of said ring 21. Ends of the clamping arms 22 are provided with bent portions 23. In FIG. 2, the clamping arms 22 are shown in a position in which they extend substantially perpendicular to the ring 21. This appearance of the clamping unit 20 is obtained on the basis of an initial form of the clamping unit 20, in which the clamping arms 22 extend entirely in the same plane as the ring 21, by bending the ends of the clamping arms 22 such as to obtain the bent portions 23, and by changing the orientation of the clamping arms 22 with respect to the ring 21. It will be understood that for the purpose of obtaining the shown appearance of the clamping unit 20 on the basis of the described initial form, it is important that the clamping unit 20 comprises bendable material.

In the shown example, the clamping unit 20 is intended to constitute one connector of the first variable focus lens package. Therefore, the clamping unit 20 comprises an electrically conducting material. Furthermore, in the shown example, the clamping unit 20 comprises two clamping arms 22 which are bent to an opposite side of the ring 21 than the bulk of the clamping arms 22. One of these two arms 22 is intended to constitute a first connector arm 24 of the first variable focus lens package. The way in which the clamping unit 20 is arranged and applied as a connector will be described in the following.

FIGS. 3-6 illustrate a way of assembling the variable focus lens package according to the first preferred embodiment of the present invention. In the following, the assembly steps are listed.

During a first assembly step, a bottom lens member 30 is placed on top of the ring 21 of the clamping unit 20. The bottom lens member 30 has a circular circumference, wherein a diameter of the bottom lens member 30 substantially corresponds to an outer diameter of the ring 21 of the clamping unit 20, so that the bottom lens member 30 is aligned with said ring 21 by means of the clamping arms 22 of the clamping unit 20.

The bottom lens member 30 comprises a lens body 31 and a stepped base plate 32 for supporting the lens body 31, wherein the lens body 31 is located on a highest step 33 of the base plate 32. In the shown example, the bottom lens member 30 further comprises a lowest step 35 and an intermediate step 34 located at a level between the highest step 33 and the lowest step 35. At least the lens body 31 is optically transparent. A top surface 36 of the bottom lens member 30 is provided with a layer of electrically conducting material, for example a layer comprising metal.

FIG. 3 shows an entirety of lens package elements 20, 30, which is obtained after the first assembly step.

During a second assembly step, a connector member 40 comprising a ring 41 and two arms 42 extending from an outer circumference of said ring 41 is placed on top of the bottom lens member 30. In the process, it is ensured that the ring 41 of the connector member 40 contacts the electrically conducting layer of the bottom lens member 30. One of the arms 42 of the connector member 40 is intended to constitute a second connector arm 43 of the first variable focus lens package. In order for the connector member 40 to be capable of actually functioning as a connector, the connector member 40 comprises an electrically conducting material, such as metal.

Like the clamping unit 20, the connector member 40 may be manufactured on the basis of an initial form in which the connector arms 42 extend entirely in the same plane as the ring 41.

An outer diameter of the ring 41 of the connector member 40 substantially corresponds to the diameter of the bottom lens member 30. The ring 41 of the connector member 40 is positioned on the lowest step 35 of the bottom lens member 30, wherein an inner diameter of the ring 41 is adapted to an outer diameter of the intermediate step 34, such that the ring 41 is capable of surrounding the intermediate step 34 without the presence of play. In this way, the connector member 40 is aligned with the bottom lens member 30.

During a third assembly step, a bottom sealing ring 50 is partly placed on top of the ring 41 of the connector member 40, and partly on the intermediate step 34 of the base plate 32 of the bottom lens member 30. The bottom sealing ring 50 is for example made of rubber. The dimensions of the bottom sealing ring 50 are chosen such that an annular space 51 between an inner circumference of the bottom sealing ring 50 and the highest step 33 of the base plate 32 of the bottom lens member 30 is obtained.

FIG. 4 shows an entirety of lens package elements 20, 30, 40, 50, which is obtained after the third assembly step.

During a fourth assembly step, the body 10 is placed on top of the bottom sealing ring 50. In the process, the body 10 is aligned with the bottom lens member 30, as the highest step 33 of the base plate 32 of the bottom lens member 30 is received in the through-hole 11 of the body 10, without the presence of play. A bottom portion of the inner portion 12 of the body 10 is received in the annular space 51. Furthermore, the thickened portion 14 which is present on the bottom side of the body 10 is pressed in the bottom sealing ring 50.

During a fifth assembly step, a number of clamping arms 22 of the clamping unit 20 are bent such as to clamp the bottom lens member 30, the connector member 40, the bottom sealing ring 50 and the body 10 between the bent portions 23 of the clamping arms 22 and the ring 21 of the clamping unit 20. In the process, ends of the bent portions 23 of the clamping arms 22 are guided by the bevelling surface 13 at the top side of the body 10. In case of any coatings being present on said bevelling surface 13, the ends of the bent portions 23 scratch through these coatings, and consequently come into direct contact with the copper body 10 itself.

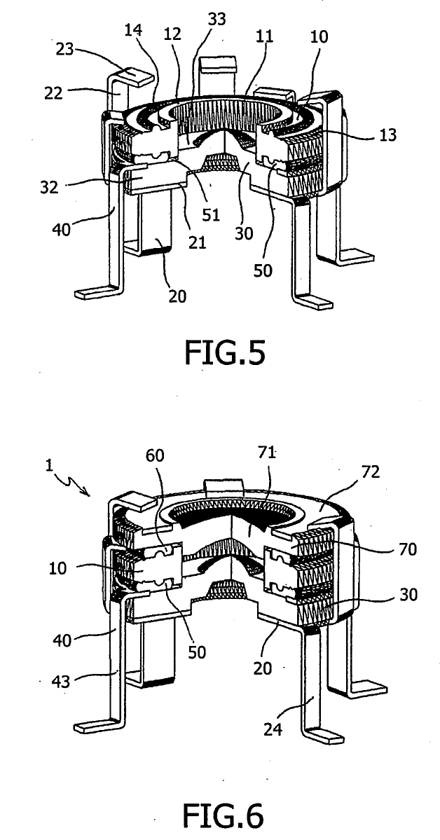

FIG. 5 shows an entirety of lens package elements 10, 20, 30, 40, 50, which is obtained after the fifth assembly step.

During a sixth assembly step, a predetermined quantity of electrically conducting fluid is put in the open container which is delimited by the top surface 36 of the bottom lens member 30 and the inner surface 15 of the through-hole 11 of the body 10. The electrically conducting fluid may for example comprise water containing a salt solution, and will hereinafter be referred to as “water”.

During a seventh assembly step, the open container as described in the preceding paragraph is further filled with an electrically insulating fluid. This electrically insulating fluid may for example comprise a silicone oil or an alkane, and will hereinafter be referred to as “oil”. The oil does not mix with the water. Instead, the oil and the water constitute two separate fluid bodies inside the through-hole 11 of the body 10. Functionally, the oil and the water have different indices of refraction. The densities of the oil and the water are preferably equal, so that the operation of the variable focus lens package is not influenced by its orientation, in other words, so that the operation of the lens package is not influenced by gravitational effects between the oil and the water.

During an eighth assembly step, a top sealing ring 60 is placed on top of the body 10. Like the bottom sealing ring 50, the top sealing ring 60 is for example made of rubber. The dimensions of the top sealing ring 60 are chosen such that the top sealing ring 60 is capable of covering an annular area of the body 10 which is present between the inner portion 12 and the bevelling surface 13. In the process, the thickened portion 14 which is present on the top side of the body 10 is pressed in the top sealing ring 60.

During a ninth assembly step, a top lens member 70 is placed on top of the top sealing ring 60. In the process, a central portion 71 of the top lens member 70 is inserted in the through-hole 11 of the body 10, without the presence of play, so that the top lens member 70 is aligned with the body 10, and, consequently, with the bottom lens member 30. At a bottom side, the top lens member 70 is coated with a hydrophobic coating. By means of this coating, water which is dissolved in the oil is prevented from causing droplets. Optionally, at a top side, the top lens member 70 comprises a metal protection ring 72.

During a tenth assembly step, clamping arms 22 of the clamping unit 20 which have not yet been used for clamping the bottom lens member 30, the connector member 40, the bottom sealing ring 50 and the body 10 against the ring 21 of the clamping unit 20, are bent such as to clamp the entire stack of the bottom lens member 30, the connector member 40, the bottom sealing ring 50, the body 10, the top sealing ring 60, the top lens member 70, and, optionally, the protection ring 72, between the bent portions 23 of the clamping arms 22 and the ring 21 of the clamping unit 20.

The result of the ten assembly steps is the variable focus lens package 1 according to the first preferred embodiment of the present invention. In FIG. 6, this first variable focus lens package 1 is shown.

In FIG. 7, a barrel 80 is shown, wherein the first variable focus lens package 1 is accommodated in said barrel 80. Additional to the first variable focus lens package 1, the barrel 80 accommodates two lens members 81, 82, which are placed below the first variable focus lens package 1. In FIG. 7, for the sake of clarity, a portion of the first variable focus lens package 1, the barrel 80 and the lens members 81, 82 is broken away.

The barrel 80 containing the first variable focus lens package 1 and the lens members 81, 82 constitutes a robust unit, which is suitable for application in a mobile phone. FIG. 8 diagrammatically shows a combination of the barrel 80 and a camera module 90. By means of the connectors of the first variable focus lens package 1, which comprise first connector arm 24 and second connector arm 43, the lens package 1 is connected to the camera module 90, which is equipped with a driver and additional components for the lens package 1. The electrical connections between the first variable focus lens package 1 and the camera module 90 may be realized in any suitable way, for example by means of soldering, welding, clamping or gluing.

The variable focus lens package 1 as shown in FIG. 6 comprises a series of three lenses. Light which falls on the first variable focus lens package 1 follows a light path through the lens package 1, wherein the light passes the top lens member 70, the oil, the water and the meniscus between these two fluids, and the bottom lens member 30. By varying the shape of the meniscus between the oil and the water, it is possible to focus the light. The way in which the shape of said meniscus is varied will be explained in the following.

The first connector arm 24 is connected to the copper body 10, through the ring 21 of the clamping unit 20 and the clamping arms 22 contacting the bevelling surface 13 at the top side of the body 10. The second connector arm 43 is connected to the water, through the layer of electrically conducting material which is provided on the top surface 36 of the bottom lens member 30. When no voltage is applied between the connector arms 24, 43, the wettability of the hydrophobic layer on the inner surface 15 of the through-hole 11 of the body 10 with respect to the oil differs from the wettability of said layer with respect to the water. Due to an effect referred to as electrowetting, the wettability of the hydrophobic layer with respect to the water is variable under the application of a voltage between the connector arms 24, 43. A change of the wettability of the hydrophobic layer leads to a change of a contact angle of the meniscus between the oil and the water, at a line of contact between the hydrophobic layer and the two fluids, whereby the shape of the meniscus is adjusted. Hence, the shape of the meniscus is dependent on the applied voltage. As the meniscus is positioned in the light path and serves for refracting light, this meniscus may be considered as a lens having a variable focus.

In order for the first variable focus lens package 1 to be suitable for application in a mobile phone, the dimensions of the various package elements need to be relatively small. For example, an inner diameter of the body 10 is 3 mm, an outer diameter of the body 10 is 6 mm, and a height of the body 10 is 1 mm.

FIG. 9 diagrammatically shows a variable focus lens package 2 according to a second preferred embodiment of the present invention.

The second variable focus lens package 2 comprises a plastic annular body 10, which is at least partially covered by a layer comprising electrically conducting material, such as metal. The electrically conducting layer is covered by a layer comprising an electrically insulating material, such as parylene, whereas the electrically insulating layer is covered by a layer comprising a hydrophobic material. The three layers covering a portion of the body 10 are diagrammatically depicted in FIG. 9 by means of a relatively thick line, which is indicated by reference numeral 16.

Like the body 10 of the first variable focus lens package 1, the body 10 of the second variable focus lens package 2 comprises bevelling surfaces 13 which are located at an outer portion. Furthermore, at a bottom side, the body 10 is provided with an annular groove 17. At a top side, the body 10 comprises two planar annular portions 18, 19, wherein an inner annular portion 18 extends from an inner circumference of the body 10 in the direction of an outer circumference of the body 10, and wherein an outer annular portion 19 is situated at a position between the inner circumference and the outer circumference. The outer annular portion 19 is located at a higher level than the inner annular portion 18, and the transition between the annular portions 18, 19 is formed by an upright wall 46.

A through-hole 11 of the body 10 is closed off by means of a bottom lens member 30 which is located at the bottom side of the body 10 and a top lens member 70 which is located at the top side of the body 10. Both lens members 30, 70 are formed as so-called replica lenses. Such lenses comprise a glass base plate 32, 74 and a plastic lens body 31, 75, and are manufactured in a manner known per se, with the use of a mould for moulding the plastic and UV-light for curing the plastic inside the mould. In FIG. 9, a central portion of the lens bodies 31, 75 of the lens members 30, 70 is not shown, as the exact shape of the lens bodies 31, 75 is not relevant in the light of the present invention. A top surface 36 of the bottom lens member 30 is covered by a layer 37, which is both hydrophilic and electrically conducting, and which comprises for example metal.

The second variable focus lens package 2 comprises a bottom sealing ring 50 and a top sealing ring 60 for sealing a fluid chamber 85 which is delimited by an inner surface 15 of the through-hole 11 of the body 10, a bottom surface 76 of the top lens member 70 and the top surface 36 of the bottom lens member 30. The top sealing ring 60 is located between the inner annular portion 18 of the body 10 and the base plate 74 of the top lens member 70, whereas the bottom sealing ring 50 is located in the groove 17 at the bottom side of the body 10, and contacts the top surface 36 of the bottom lens member 30.

According to an important aspect of the present invention, at both the top surface 36 of the bottom lens member 30 and the bottom surface 76 of the top lens member 70, a positioning ring 38, 77 is arranged on the lens members 30, 70. The positioning rings 38, 77 play a role in aligning the lens members 30, 70 with respect to each other and with respect to the through-hole 11 of the body 10. On the one hand, an outer diameter of a bottom positioning ring 38 is chosen such that when the bottom lens member 30 is put in place with respect to the body 10, an outer circumference of the bottom positioning ring 38 contacts an outer wall 45 of the groove 17, without the presence of play. In this way, a central axis of the lens body 31 of the bottom lens member 30 is exactly aligned with a central axis of the through-hole 11 of the body 10. On the other hand, an outer diameter of a top positioning ring 77 is chosen such that when the top lens member 70 is put in place with respect to the body 10, an outer circumference of the top positioning ring 77 contacts the upright wall 46, without the presence of play. In this way, a central axis of the lens body 75 of the top lens member 70 is exactly aligned with the central axis of the through-hole 11 of the body 10, and consequently also with the central axis of the lens body 31 of the bottom lens member 30.

For the purpose of fixing the various lens package elements 10, 30, 50, 60, 70, with respect to each other, two clamping units 20a, 20b are provided. The clamping units 20a, 20b comprise a ring 21a, 21b and a number of clamping arms 22a, 22b extending from an outer circumference of said ring 21a, 21b. Ends of the clamping arms 22a, 22b are provided with bent portions 23a, 23b.

A bottom clamping unit 20a is arranged such as to clamp the bottom lens member 30 against the body 10, wherein the bottom sealing ring 50 is clamped between the bottom lens member 30 and the body 10. During assembly of the second variable focus lens package 2, ends of the bent portions 23a of the clamping arms 22a are guided by the bevelling surface 13 at the top side of the body 10. In the process, the ends of the bent portions 23 scratch through the hydrophobic layer and the electrically insulating layer, and consequently come into direct contact with the electrically conducting layer.

A top clamping unit 20b is arranged such as to clamp the top lens member 70 against the body 10, wherein the top sealing ring 60 is clamped between the top lens member 70 and the body 10. Ends of the bent portions 23b of the clamping arms 22b contact the layer 37 covering the top surface 36 of the bottom lens member 30. In the shown example, the ends of the bent portions 23b comprise elastic fingers 25 which are biased to spring outwards, so that the ends are firmly clamped between the bevelling surface 13 at the bottom side of the body 10 and the top surface 36 of the bottom lens member 30. In this way, contact between the ends of the bent portions 23b and the layer 37 covering the top surface 36 of the bottom lens member 30 is guaranteed.

Like the first variable focus lens package 1, the second variable focus lens package 2 comprises a quantity of water 86 and a quantity of oil 87. The water 86 and the oil 87 are present in the fluid chamber 85, wherein the water 86 is situated at a bottom side of the fluid chamber 85, and wherein the oil 87 is situated at a top side of the fluid chamber 85. The water 86 and the oil 87 are separated by a meniscus 88. The shape of this meniscus 88 is variable under the influence of a voltage between the electrically conducting layer of the body 10 and the water 86, as the wettability of the hydrophobic layer with respect to the water is variable under the application of a voltage. In the second variable focus lens package 2, connectors for supplying the voltage are constituted by the clamping units 20a, 20b. In this respect, for completeness' sake, it is noted that the ends of the bent portions 23a of the clamping arms 22a of the bottom clamping unit 20a are in contact with the electrically conducting layer of the body 10, and that the ends of the bent portions 23b of the clamping arms 22b of the top clamping unit 20b are in contact with the water 86, through the electrically conducting layer 37 of the bottom lens member 30.

The top sealing ring 60 is surrounded by a resilient ring 65, which, for example, is made of metal. The top sealing ring 60 and the surrounding resilient ring 65 are arranged such as to be able to expand and to shrink. In this way, the top sealing ring 60 and the surrounding resilient ring 65 are capable of compensating for variations of the volume of the water 86 and the oil 87 by keeping a pressure prevailing inside the fluid chamber 85 at a substantially fixed level. Variation of the volume of the water 86 and the oil 87 may occur during operation of the second variable focus lens package 2, for example under the influence of the temperature. If the variation of the volume of the water 86 and the oil 87 is not compensated for, air bubbles arise in these fluids 86, 87, which hinder the operation of the second variable focus lens package 2 to such an extent that this lens package 2 has become useless.

The second variable focus lens package 2 is assembled in several steps, which are listed in the following. The assembly starts with the bottom clamping unit 20a, which is shown in FIG. 10.

During a first assembly step, the bottom lens member 30 is placed on top of the ring 21a of the bottom clamping unit 20a. In the process, the base plate 32 of the bottom lens member 30 is positioned between the clamping arms 22a of the bottom clamping unit 20a.

FIG. 11 shows an entirety of lens package elements 20a, 30, which is obtained after the first assembly step.

During a second assembly step, the bottom sealing ring 50 is positioned in the groove 17 at the bottom side of the body 10. Subsequently, the body 10 is put in place with respect to the bottom lens member 30, wherein the outer circumference of the bottom positioning ring 38 contacts the outer wall 45 of the groove 17, whereby the position of the body 10 is fixed with respect to the bottom lens member 30 in a transversal direction.

During a third assembly step, the bottom clamping unit 20a is bent around the body 10 and the bottom lens member 30, wherein the ring 21a of the bottom clamping unit 20a rests on a bottom surface 39 of the bottom lens member 30, and wherein the bent portions 23a of the clamping arms 22a rest on the top side of the body 10, at a position beyond the bevelling surface 13. In the process, ends of the bent portions 23a of the clamping arms 22a are guided by the bevelling surface 13 at the top side of the body 10, wherein the ends of the bent portions 23 scratch through the hydrophobic layer and the electrically insulating layer, and consequently come into direct contact with the electrically conducting layer.

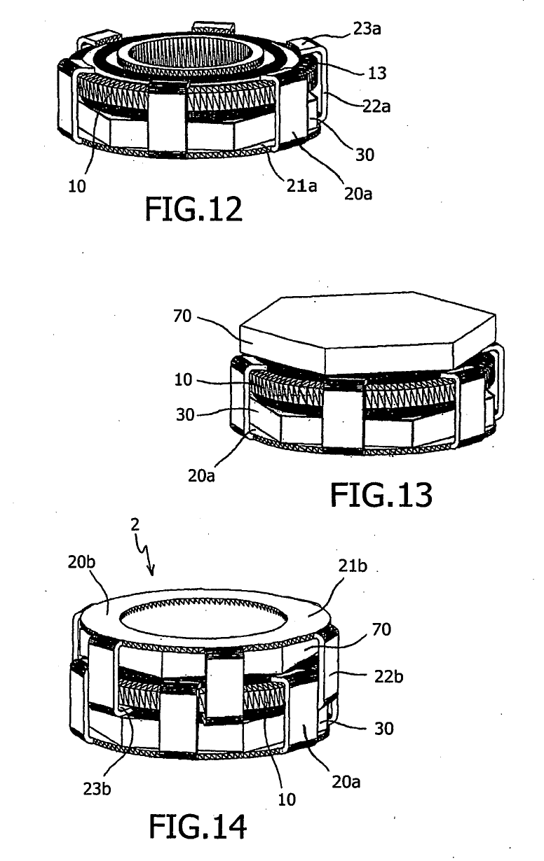

FIG. 12 shows an entirety of lens package elements 10, 20a, 30, 50, which is obtained after the third assembly step.

During a fourth assembly step, a predetermined quantity of water 86 is put in the open container which is delimited by the top surface 36 of the bottom lens member 30 and the inner surface 15 of the through-hole 11 of the body 10. Subsequently, the open container is further filled with oil.

During a fifth assembly step, the top sealing ring 60 and the resilient ring 65 are placed on top of the inner annular portion 18 at the top side of the body 10. Subsequently, the top lens member 70 is put in place with respect to the body 10, wherein the outer circumference of the top positioning ring 77 contacts the upright wall 46, whereby the position of the top lens member 70 is fixed with respect to the body 10 in a transversal direction.

FIG. 13 shows an entirety of lens package elements 10, 20a, 30, 50, 60, 65, 70, which is obtained after the fifth assembly step.

During a sixth assembly step, the top clamping unit 20b is put in place, and is bent around the body 10 and the top lens member 70, wherein the ring 21b of the top clamping unit 20b rests on a top surface 78 of the top lens member 70, and wherein the bent portions 23b of the clamping arms 22b are clamped between the bevelling surface 13 at the bottom side of the body 10 and the top surface 36 of the bottom lens member 30. Consequently, the ends of the bent portions 23b come into direct contact with the electrically conducting layer 37 of the bottom lens member 30.

The result of the six assembly steps is the variable focus lens package 2 according to the second preferred embodiment of the present invention. A diagrammatical perspective view of this second variable focus lens package 2 is shown in FIG. 14. The focus of this lens package 2 may be varied by applying a voltage through the connectors of this lens package 2, which are constituted by the clamping units 20a, 20b.

Summarizing, the second variable focus lens package 2 may be described as follows: the second variable focus lens package 2 comprises an annular body 10 having a through-hole 11, which is closed off by means of lens members 30, 70, and which is sealed by means of sealing rings 50, 60. The through-hole 11 is filled with quantities of water 86 and oil 87, which are separated by a meniscus 88. The various lens package elements are fixed with respect to each other by means of clamping units 20a, 20b. By this arrangement, a very compact and robust lens package 2 is obtained.

A portion of the surface of the body 10 is covered with an electrically conducting layer. The shape of the meniscus 88 is variable under the influence of a voltage between this electrically conducting layer and the water 86. In this way, the meniscus 88 is applicable as a lens having an adjustable focus.

FIG. 15 diagrammatically shows a perspective view of a variable focus lens package 3 according to a third embodiment of the present invention, which resembles the second variable focus lens package 2 to a large extent. A relevant difference between the two variable focus lens packages 2, 3 is that the third variable focus lens package 3 additionally comprises a connector member 40 for contacting the electrically conducting layer 37 of the bottom lens member 30. Consequently, the connectors of the third variable focus lens package 3 are constituted by the bottom clamping unit 20a and the connector member 40. It will be understood that in the third variable focus lens package 3, the elastic fingers 25 which are present at the ends of the bent portions 23b of the clamping arms 22b of the top clamping unit 20b of the second variable focus lens package 2, are omitted.

Like the connector member 40 of the first variable focus lens package 1, the connector member 40 of the third variable focus lens package 3 comprises a ring 41 and two arms 42 extending from an outer circumference of said ring 41.

Besides the presence of the connector member 40, and the absence of contact between the ends of the bent portions 23b of the clamping arms 22b of the top clamping unit 20b and the electrically conducting layer 37 of the bottom lens member 30, there are no structural differences between the third variable focus lens package 3 and the second variable focus lens package 2.

It will be clear to a person skilled in the art that the scope of the present invention is not limited to the examples discussed in the foregoing, but that several amendments and modifications thereof are possible without deviating from the scope of the present invention as defined in the attached claims.

For example, it will be understood that it is possible to apply other means than the shown rubber sealing rings 50, 60 for sealing the fluid chamber 85 of the variable focus lens package 1, 2, 3, for example O-rings.

It is not necessary to apply the clamping units 20 as connectors of the variable focus lens package 1, 2, 3, although this is a very advantageous option. Within the scope of the present invention, it is possible to arrange additional connectors, wherein one connector is in contact with an electrically conducting portion of the body 10, and wherein another connector is in contact with the water 86 inside the fluid chamber 85 of the variable focus lens package 1, 2, 3.

The base plate 32, 74 of the lens members 30, 70 may have any suitable shape, and may for example be square or hexagonal. The latter is the case in the shown second variable focus lens package 2 and the shown third variable focus lens package 3. The shape of the clamping units 20, in particular the positions of the clamping arms 22, is adapted to the shape of the base plates 32, 74.

In the shown embodiments of the variable focus lens package 1, 2, 3 according to the present invention, a bottom lens member 30 and a top lens member 70 are applied, so that the lens package 1, 2, 3 actually comprises a series of three lenses. It is not necessary that additional lenses are applied. Instead, it is possible that at least one of the lens members 30, 70 is replaced by a cover having no functioning in focussing the light.

For the purpose of compensating for variations of the volume of the water 86 and the oil 87, various solutions exist, which boil down to the application of an expansion member. The solution which is applied in the second variable focus lens package 2 and the third variable focus lens package 3 comprises a resilient ring 65 surrounding the top sealing ring 60. Another feasible solution comprises a recess arranged in the body 10 and a membrane for covering the recess, wherein the membrane is at least partly flexible.

FIG. 16 diagrammatically shows an exploded view of a section of a variable focus lens package 4 according to a fourth preferred embodiment of the present invention and two conventional plastic lens members 81, 82 arranged below the lens package 4.

Like the above-described lens packages 1, 2, 3, the fourth lens package 4 comprises a bottom lens member 30, a body 10 having a through-hole 11, a bottom sealing ring 50 and a top sealing ring 60, and a top lens member 70, wherein a top surface 36 of the bottom lens member 30 is covered by an electrically conducting layer 37. Furthermore, like the above-described lens packages 1, 2, 3, the fourth lens package 4 comprises quantities of water and oil (not shown in FIG. 16), which are separated by a meniscus, wherein the shape of the meniscus is variable under the influence of a voltage between the body 10 and the water.

In the shown example, the bottom lens member 30 comprises a replica lens having three layers. The replica lens comprises a glass base plate 32, which is sandwiched between a plastic bottom lens layer 31a of which a central portion constitutes a concave lens body, and a plastic top lens layer 31b of which a central portion constitutes a convex lens body. Further, in the shown example, the top lens member 70 also comprises a replica lens. This replica lens of the top lens member 70 comprises a glass base plate 74 and a plastic top lens layer 75 of which a central portion constitutes a convex lens body.

An important feature of the fourth variable focus lens package 4 is that the body 10 itself may be used as an electrical connector of the lens package 4, wherein it is not necessary that an additional element for contacting the body 10 is applied. In order to avoid short-circuiting between the body 10 and the layer 37 of the bottom lens member 30, a bottom surface 26 of the body 10 is covered by an electrically insulating layer 27, at least at the areas where the body 10 rests on the bottom lens member 30. The shown body 10 is designed such as not to contact the top surface 36 of the bottom lens member 30 at an end of an inner portion 12 of the body 10.

The body 10 may comprise clamping arms (not shown in FIG. 16) for fixing the bottom lens member 30. However, it is also possible that clamping means for clamping the bottom lens member 30 against the body 10 are provided, which are not formed as an integral part of the body 10. The top lens member 70 may be fixed with respect to the body 10 in any suitable way, for example also by means of clamping means.

Besides the connector which is constituted by the body 10, the fourth variable focus lens package 4 needs to comprise another connector (not shown in FIG. 16), which is in contact with the electrically conducting layer 37 of the bottom lens member 30, in order to be in contact with the water through this layer 37. This connector may be shaped and arranged in any suitable way, wherein it is important that the connector does not contact the body 10.

The variable focus lens packages 1, 2, 3, 4 may be applied in hand-held apparatus, such as mobile phones and optical scanning devices for use in digital recording-equipment.

A number of lens packages 1, 2, 3, 4 may be positioned in a row, wherein the through-holes 11 of the lens packages 1, 2, 3, 4 are aligned with respect to each other, in order to create a zoom lens.

The lens packages 1, 2, 3, 4 according to the present invention are particularly intended for application in a camera, which further comprises an image sensor and an interconnecting body, wherein the interconnecting body comprises electrically conductive tracks arranged on a first surface and a second surface of the interconnecting body, and wherein the electrically conductive tracks are shaped such as to be able to establish a connection between both the image sensor and the variable focus lens package 1, 2, 3, 4 to driver electronics therefore, or to contact pads. In this respect, it is noted that a combination of the variable focus lens package 1, 2, 3, 4 and a camera module 90 has already been described in relation to the first lens package 1.

The camera may be part of the above-mentioned hand-held apparatus, which may further comprise input means, information processing means and display means.

1. Variable focus lens package (1, 2, 3), comprising:
a body (10), which is provided with a through-hole (11) for providing a light path through the body (10), wherein at least a surface layer of the body (10) comprises an electrically conducting material;
covers (30, 70) for closing off the through-hole (10), which are optically transparent in the light path;
an electrically insulating fluid (87) and an electrically conducting fluid (86), which are contained by a fluid chamber (85) enclosed by the covers (30, 70) and an inner surface (15) of the through-hole (11) of the body (10), which are non-miscible, and which are in contact over a meniscus (88), wherein a shape of the meniscus (88) is variable under the application of a voltage between the electrically conducting surface of the body (10) and the electrically conducting fluid (86);
an electrically insulating layer covering at least the portion of the surface of the body (10) contacting the electrically conducting fluid (86);
sealing means (50, 60) for sealing the fluid chamber (85); and
clamping means (20) for fixing the body (10), the covers (30, 70) and the sealing means (50, 60) with respect to each other under the exertion of clamping forces.

2. Variable focus lens package (1, 2, 3) according to claim 1, wherein the clamping means (20) contact at least one of the electrically conducting surface of the body (10) and the electrically conducting fluid (86).

3. Variable focus lens package (1, 2, 3) according to claim 2, wherein the clamping means comprise at least one clamping unit (20) having a ring (21) and clamping arms (22) extending from an outer circumference of said ring (21).

4. Variable focus lens package (1, 2, 3) according to claim 1, wherein at least one of the covers (30, 70) is capable of functioning as a lens.

5. Variable focus lens package (1, 2, 3) according to claim 4, wherein the cover (30, 70) capable of functioning as a lens comprises a glass base plate (32, 74) and a plastic lens body (31, 75) attached to the base plate (32, 74).

6. Variable focus lens package (1, 2, 3) according to claim 4, comprising aligning means (33, 71; 38, 77) for aligning the cover (30, 70) capable of functioning as a lens with respect to the meniscus (88) between the electrically insulating fluid (87) and the electrically conducting fluid (86).

7. Variable focus lens package (2, 3) according to claim 6, wherein the aligning means comprise an annular positioning member (38, 77) provided on the cover (30, 70) capable of functioning as a lens.

8. Variable focus lens package (1, 2, 3) according to claim 1, wherein the sealing means comprise at least one sealing ring (50, 60), which preferably comprises rubber.

9. Variable focus lens package (1, 2, 3) according to claim 1, comprising at least one expansion member (60, 65) which is partially flexible and which is part of a circumscription of the fluid chamber (85), wherein said expansion member (60, 65) is capable of compensating for variations of the volume of the fluids (86, 87) by keeping a pressure prevailing inside the fluid chamber (85) at a substantially fixed level.

10. Variable focus lens package (2, 3) according to claim 9, wherein the expansion member comprises the sealing means (60).

11. Variable focus lens package (1, 2, 3), comprising:
a body (10), which is provided with a through-hole (11) for providing a light path through the body (10), wherein at least a surface layer of the body (10) comprises an electrically conducting material;
covers (30, 70) for closing off the through-hole (10), which are optically transparent in the light path;
an electrically insulating fluid (87) and an electrically conducting fluid (86), which are contained by a fluid chamber (85) enclosed by the covers (30, 70) and an inner surface (15) of the through-hole (11) of the body (10), which are non-miscible, and which are in contact over a meniscus (88), wherein a shape of the meniscus (88) is variable under the application of a voltage between the electrically conducting surface of the body (10) and the electrically conducting fluid (86);
an electrically insulating layer covering at least the portion of the surface of the body (10) contacting the electrically conducting fluid (86); and
sealing means (50, 60) for sealing the fluid chamber (85);
wherein at least one of the covers (30, 70) is capable of functioning as a lens.

12. Variable focus lens package (1, 2, 3) according to claim 11, wherein the cover (30, 70) capable of functioning as a lens comprises a glass base plate (32, 74) and a plastic lens body (31, 75) attached to the base plate (32, 74).

13. Variable focus lens package (4), comprising:
a body (10), which is provided with a through-hole (11) for providing a light path through the body (10), wherein at least a surface layer of the body (10) comprises an electrically conducting material;
covers (30, 70) for closing off the through-hole (10), which are optically transparent in the light path;
an electrically insulating fluid (87) and an electrically conducting fluid (86), which are contained by a fluid chamber (85) enclosed by the covers (30, 70) and an inner surface (15) of the through-hole (11) of the body (10), which are non-miscible, and which are in contact over a meniscus (88), wherein a shape of the meniscus (88) is variable under the application of a voltage between the electrically conducting surface of the body (10) and the electrically conducting fluid (86);
an electrically insulating layer covering at least the portion of the surface of the body (10) contacting the electrically conducting fluid (86);
sealing means (50, 60) for sealing the fluid chamber (85);
two electrical connectors for applying a voltage, wherein at least a portion of the electrical connectors is arranged at the outside of the variable focus lens package (4), wherein one electrical connector is in contact with the electrically conducting fluid (86), and wherein the body (10) serves as another electrical connector.

14. Camera comprising a camera module (90) and a variable focus lens package (1, 2, 3, 4) according to claim 1.

15. Hand-held apparatus comprising a camera according to claim 14, and further comprising input means, information processing means and display means.
